(19) United States
(12) Patent Application Publication
(10) Pub. No.: US 2018/0170045 A1
(43) Pub. Date: Jun. 21, 2018

(54) LIQUID EJECTION HEAD AND LIQUID EJECTION APPARATUS

(71) Applicant: TOSHIBA TEC KABUSHIKI KAISHA, Tokyo (JP)

(72) Inventors: MengFei WONG, Mishima Shizuoka (JP); Ryutaro KUSUNOKI, Mishima Shizuoka (JP); Shuhei YOKOYAMA, Mishima Shizuoka (JP); Ryuichi ARAI, Numazu Shizuoka (JP); Masayuki SATOMI, Sunto Shizuoka (JP)

(21) Appl. No.: 15/693,405

(22) Filed: Aug. 31, 2017

(30) Foreign Application Priority Data
Dec. 21, 2016 (JP) 2016-248348

(51) Int. Cl. B41J 2/145; B41J 2/14

(52) U.S. Cl. CPC B41J 2/145; B41J 2/14

(57) ABSTRACT

According to one embodiment, a liquid ejection head includes a first base having a plurality of nozzles from which liquid can be ejected, a second base on the first base and having a plurality of pressure chambers in fluid communication with the plurality of nozzles, and a third base located on the second base, with the second base being interposed between the first and third bases, the third base having a common chamber in fluid communication with the plurality of pressure chambers, an inner wall of the common chamber has an uneven surface portion shaped so as to trap air bubbles entrained in the liquid to be ejected from the plurality of nozzles.

### CROSS-REFERENCE TO RELATED APPLICATION

This application is based upon and claims the benefit of priority from Japanese Patent Application No. 2016-248348, filed Dec. 21, 2016, the entire contents of which are incorporated herein by reference.

### FIELD

Embodiments described herein relate generally to a liquid ejection head and a liquid ejection apparatus.

### BACKGROUND

In a liquid ejection head, such as an inkjet head, a nozzle plate has a plurality of nozzles associated with piezoelectric drive elements. The liquid ejection head includes, for example, a first component including the nozzle plate with a plurality of nozzles and drive elements, a second component including a plurality of pressure chambers connected to the nozzles, and a third component including a common chamber connected to the plurality of pressure chambers. Voltages applied to the drive elements cause pressure changes in the pressure chambers, which in turn cause the ejection of liquid from the nozzles. A liquid storage tank is connected to the liquid ejection head, and a liquid is circulated through the liquid ejection head and the liquid storage tank along a cyclic path connecting these components.

In a liquid ejection head of this configuration, air bubbles may be introduced from the nozzles. Since the air bubbles that move along the cyclic path and pass through the common chamber can cause ejection failures if they move to other nozzles at the downstream side, a technique to prevent or reduce ejection failures caused by air bubbles is desirable.

### BRIEF DESCRIPTION OF THE DRAWINGS

FIG. 1 is a diagram of a liquid ejection apparatus according to a first embodiment.

FIG. 2 is a perspective view of a liquid ejection head of a liquid ejection apparatus.

FIG. 3 is an exploded perspective view of a liquid ejection head.

FIG. 4 is a cross-sectional view of a liquid ejection head.

FIG. 5 is a cross-sectional view of a part of a liquid ejection head according to a second embodiment.

FIG. 6 is a plan view of a liquid ejection head according to the second embodiment.

FIG. 7 is a sectional view of a liquid ejection head according to a third embodiment.

FIG. 8 is a plan view of a liquid ejection head according to the third embodiment.

FIG. 9 is a cross-sectional view of a liquid ejection head according to a fourth embodiment.

### DETAILED DESCRIPTION

In general, according to one embodiment, a liquid ejection head includes a first base having a plurality of nozzles from which liquid can be ejected, a second base on the first base and having a plurality of pressure chambers in fluid communication with the plurality of nozzles, and a third base located on the second base, with the second base being interposed between the first and third bases, the third base having a common chamber in fluid communication with the plurality of pressure chambers, an inner wall of the common chamber has an uneven surface portion shaped so as to trap air bubbles entrained in the liquid to be ejected from the plurality of nozzles.

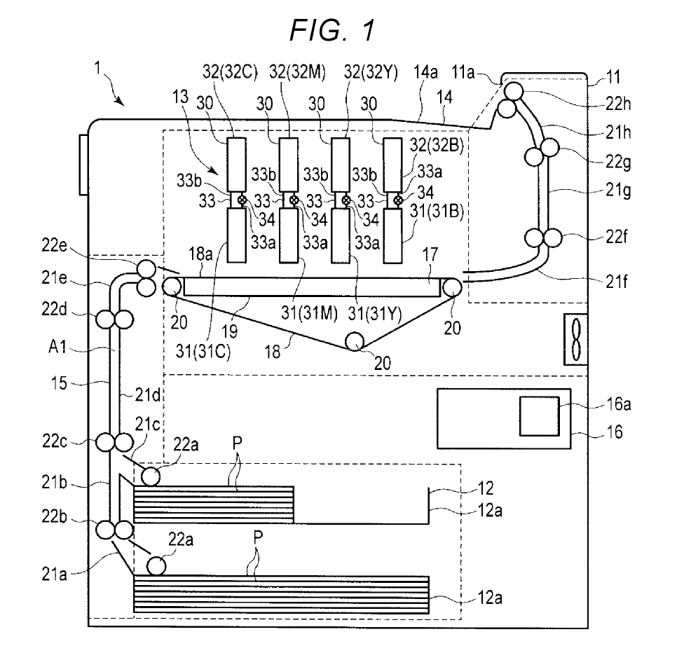

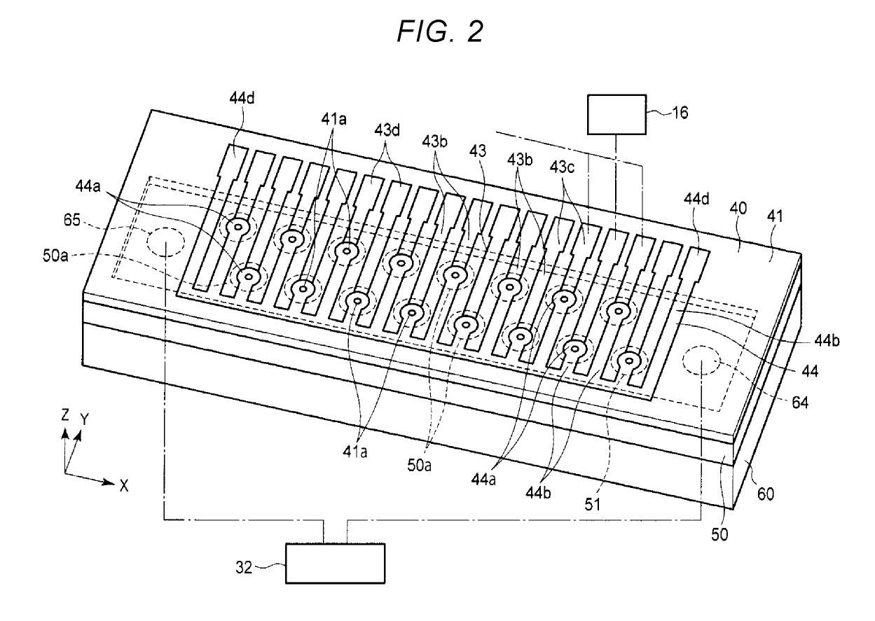

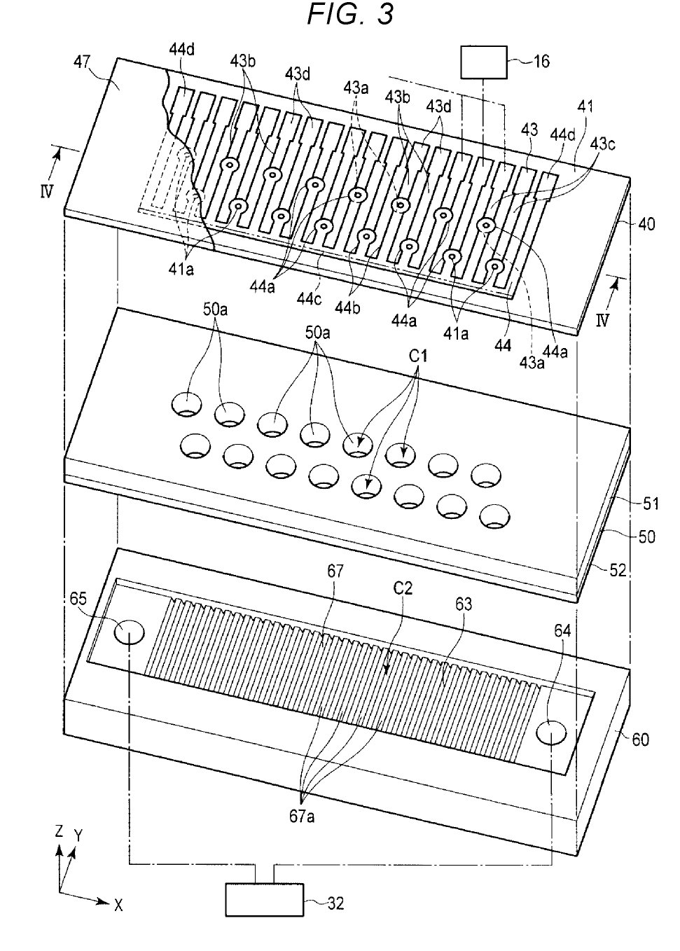

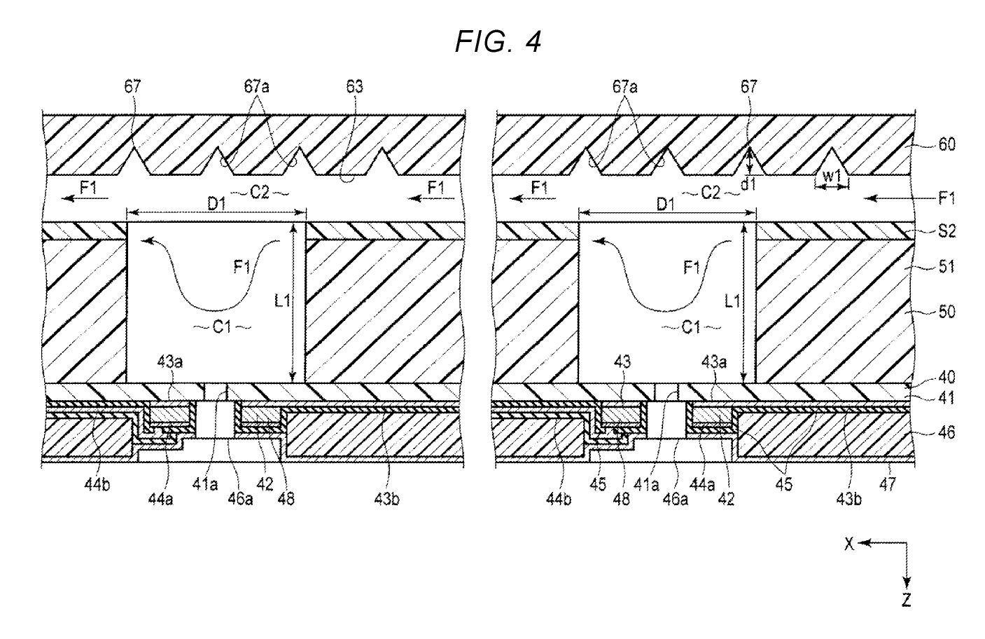

Hereinafter, configurations of an inkjet recording apparatus 1, as an example of a liquid ejection apparatus, and an inkjet head 31, as an example of a liquid ejection head, according to a first embodiment are described with reference to FIG. 1 to FIG. 4. FIG. 1 is an explanatory diagram of the inkjet recording apparatus 1, as an example of a liquid ejection apparatus. FIG. 2 is a perspective view of the inkjet head 31, and FIG. 3 is an exploded perspective view thereof. FIG. 4 is a cross-sectional view of the inkjet head 31. In these figures, X, Y, and Z represent three directions which are orthogonal to one another. Furthermore, in the first embodiment, an orientation in which nozzles 41a of the inkjet head 31 face in a downward direction is described as a direction Z, but the directions are not limited to such description.

As illustrated in FIG. 1, the inkjet recording apparatus 1 includes a chassis 11, a medium supply unit 12, an image forming unit 13, a medium discharge unit 14, a conveyance device 15, and a control unit 16.

The inkjet recording apparatus 1 is a liquid ejection apparatus which ejects ink and thus performs image formation processing on a recording medium such as a sheet P, while the medium is being conveyed along a predetermined conveyance path A1 from the medium supply unit 12 to the medium discharge unit 14 through the image forming unit 13.

The chassis 11 comprises an outer frame of the inkjet recording apparatus 1. A discharge port 11a, through which the sheet P is discharged to the outside, is provided at a predetermined portion of the chassis 11.

The medium supply unit 12 includes a plurality of sheet feed cassettes 12a. Thus, a plurality of sheet feed cassettes 12a is provided in the chassis 11. The plurality of sheet feed cassettes 12a each has a predetermined box shape with the upper side thereof open and can each hold a plurality of sheets P of various sizes placed thereon in a stack.

The medium discharge unit 14 includes a sheet discharge tray 14a. The sheet discharge tray 14a is provided in the vicinity of the discharge port 11a of the chassis 11. The sheet discharge tray 14a can hold sheets P discharged from the discharge port 11a.

The image forming unit 13 includes a supporting unit 17 for supporting a sheet P, and a plurality of head units 30 located above and opposite the supporting unit 17.

The supporting unit 17 includes a conveyance belt 18 having a loop shape at a predetermined region where image formation is performed, a supporting plate 19 for supporting the conveyance belt 18 from the back side thereof, and a plurality of belt rollers 20 provided on the back side of the conveyance belt 18.

The supporting unit 17 supports the sheet P on a holding surface 18a, which is the upper surface of the conveyance belt 18, during image formation, and conveys the sheet P toward the downstream side by driving the conveyance belt 18 at predetermined timing by the rotation of the belt rollers 20.

The head units 30 include a plurality of inkjet heads 31, for example, of four colors, ink tanks 32, as liquid tanks mounted above the respective inkjet heads 31, connection flow paths 33, each of which connects the inkjet head 31 to the ink tank 32, and circulation pumps 34, each of which serves as a circulation unit. The head unit 30 is a circulation-type head which continuously circulates liquid through the ink tank 32 and a common chamber C2 and pressure chambers C1 inside the inkjet head 31. In the first embodiment, the inkjet heads 31 include inkjet heads 31C, 31M, 31Y, and 31B of four colors, i.e., cyan, magenta, yellow, and black, and the ink tanks 32 include ink tanks 32C, 32M, 32Y, and 32B, which respectively contain ink of these colors. The ink tanks 32 are each connected to the respective inkjet head 31 by the connection flow path 33. The connection flow path 33 includes a supply flow path 33a, which is connected to a supply port 64 of the inkjet head 31, and a collection flow path 33b, which is connected to a discharge port 65 of the inkjet head 31.

Furthermore, a negative-pressure control device, such as a pump (not illustrated), is connected to the ink tank 32. Then, the negative-pressure control device performs control to make the pressure inside the ink tank 32 a negative pressure with a hydraulic head difference between the inkjet head 31 and the ink tank 32, thus causing ink supplied to each nozzle of the inkjet head 31 to be formed into a meniscus of a predetermined shape.

The circulation pump 34 is a liquid supply pump comprising, for example, a piezoelectric pump. The circulation pump 34 is provided in the supply flow path 33a. The circulation pump 34 is connected to a drive circuit of the control unit 16 by wiring lines, and can be controlled by a control operation of a central processing unit (CPU) 16a. The circulation pump 34 circulates ink in a circulation flow path which contains the inkjet head 31 and the ink tank 32.

The conveyance device 15 conveys a sheet P along the conveyance path A1 from the sheet feed cassette 12a of the medium supply unit 12 to the sheet discharge tray 14a of the medium discharge unit 14 through the image forming unit 13. The conveyance device 15 includes a plurality of guide plate pairs 21a to 21h disposed along the conveyance path A1 and a plurality of conveyance rollers 22a to 22h.

Each of the plurality of guide plate pairs 21a to 21h includes a pair of plate members located opposite to each other across the sheet P conveyed, and guides the sheet P along the conveyance path A1.

The conveyance rollers 22a to 22h include a sheet feed roller 22a, conveyance roller pairs 22b to 22g, and a discharge roller pair 22h. These conveyance rollers 22a to 22h are driven to rotate by the control operation of the CPU 16a of the control unit 16, thus sending the sheet P toward the downstream side along the conveyance path A1. Furthermore, sensors which detect the conveyance status of the sheet P are disposed at several portions of the conveyance path A1.

The control unit 16 includes a central processing unit (CPU) 16a, which is a controller, a read-only memory (ROM) which stores, for example, various programs, a random access memory (RAM) which temporarily stores, for example, various pieces of variable data and image data, and an interface unit which performs inputting and outputting of data from/to an external component.

As illustrated in FIG. 2 to FIG. 4, the inkjet head 31 includes a first base 40, which has a plurality of nozzles 41a, a second base 50, which is located on the upper side of the first base 40 serving as one of the sides thereof in which a plurality of pressure chambers C1 communicating with the respective associated nozzles 41a is formed, and a third base 60, which is located on the upper side of the second base 50 serving as one of the sides thereof in which a common chamber C2 communicating with the plurality of pressure chambers C1 is formed. Here, a “base” refers to a plate-like sub-component of the inkjet head. Furthermore, in FIG. 2 and FIG. 3, wiring layers 44 and 43 are exposed while an insulating layer 45, a protective layer 46, and an ink-repellent layer 47 are omitted from the illustrations.

As depicted in FIG. 4, the first base 40 includes a nozzle plate 41, a first wiring layer 43 formed on a lower surface of the nozzle plate 41, piezoelectric elements 42, a second wiring layer 44, an insulating layer 45, a protective layer 46, and an ink-repellent layer 47. Here, the lower surface of the nozzle plate 41 refers to a surface of the nozzle plate 41 facing the sheet P.

The nozzle plate 41 is, for example, a silicon wafer in a rectangular plate shape. The nozzle plate 41 is a silicon dioxide (SiO₂) film with a thickness of, for example, about 4 μm. It is desirable that the film thickness of the nozzle plate 41 be in the range of 1 μm to 50 μm. For example, the nozzle plate 41 is formed integrally with the second base 50 and is formed by being heat-treated in the presence of oxygen. The nozzle plate 41 has a plurality of nozzles 41a, each of which is a through-hole configured to eject liquid. The nozzles 41a include two nozzles arranged side by side in the direction Y by eight nozzles arranged side by side in the direction X. The first wiring layer 43, the piezoelectric elements 42, and the second wiring layer 44 are formed and stacked in layers on the surface of the nozzle plate 41.

The first wiring layer 43 is a thin film of, for example, platinum (Pt) and aluminum (Al). The first wiring layer 43 includes a plurality of individual wirings 43c arranged in parallel in the direction X, each of which integrally includes a first electrode 43a of a ring-like shape formed on the outer edge of each nozzle 41a on the surface of the nozzle plate 41, a pattern wiring 43b of a linear shape drawn out of the first electrode 43a in the direction Y, and a contact portion 43d to be electrically connected to an external element. Corresponding to the respective positions of the nozzles 41a, one individual wiring 43c is formed with respect to each nozzle 41a.

The piezoelectric element 42 is formed and stacked on the first electrode 43a of the first wiring layer 43. The piezoelectric element 42 is a film with a predetermined thickness formed of a piezoelectric material, such as lead zirconate titanate (Pb(Zr,Ti)O₃) (PZT). The piezoelectric element 42 has a ring-like shape surrounding the periphery of the nozzle 41a. The piezoelectric element 42 generates polarization in the direction of the thickness thereof. Thus, when an electric field in the direction of the polarization is applied to the piezoelectric element 42, the piezoelectric element 42 contracts or expands in a direction perpendicular to the direction of the electric field, that is, in a direction perpendicular to the film thickness but parallel to the in-plane direction.

The second wiring layer 44 is formed at a predetermined region covering the surfaces of the first wiring layer 43 and the piezoelectric element 42 on the surface of the nozzle plate 41.

For the second wiring layer 44, second electrodes 44a, a plurality of pattern wiring portions 44b, a common pattern wiring portion 44c, and contact portions 44d are integrated in a comb-like shape.

The second electrodes 44a are configured as a plurality of ring shapes each disposed on the piezoelectric element 42 at the outer edge of each nozzle 41a.

The plurality of pattern wiring portions 44b are aligned in a line respectively drawn out of the plurality of second electrodes 44a in the direction Y. The common pattern wiring portion 44c has a line shape extending along the direction X and interconnects end portions of the plurality of pattern wiring portions 44b opposite to the second electrodes 44a at the other end. The contact portions 44d to be electrically connected to an external element are formed at end portions of the pattern wiring portions 44b at both ends of the second wiring layer 44 in the direction X.

A stack of the first electrode 43a, the piezoelectric element 42, and the second electrode 44a forms a drive element 48 having a ring shape (or annular shape) surrounding the circumference of the nozzle 41a. Since the drive element 48 is formed with the first electrode 43a disposed on one side of the piezoelectric element 42 and the second electrode 44a disposed on the other side of the piezoelectric element 42, when voltages are selectively applied to both the electrodes 43a and 44a, the piezoelectric element 42 deforms to cause a pressure change in the pressure chamber C1, and thus ejects liquid from the nozzle 41a.

The insulating layer 45 is a film of SiO₂. The insulating layer 45 is formed at a predetermined area on the first wiring layer 43 and at a predetermined area on the second wiring layer 44. The insulating layer 45 insulates the first wiring layer and the second wiring layer 44 from each other at predetermined areas. Furthermore, the insulating layer 45 can be formed of another material such as silicon nitride (SiN).

The protective layer 46 is formed of a material different from that of the insulating layer 45, such as photosensitive polyimide like Photoneece® manufactured by Toray Industries, Inc. The protective layer 46 is formed at areas other than the drive elements 48 on the surface of the nozzle plate 41. The protective layer 46 is formed while being bonded to the nozzle plate 41 and is thus configured to prevent buckling distortion of the nozzle plate 41. The protective layer 46 has circular openings 46a at positions corresponding to the respective nozzles 41a.

The ink-repellent layer 47 is a film formed on the protective layer 46 and on the insulating layer 45 located at the opening 46a. The ink-repellent layer 47 is formed of a silicon-based liquid-repellent material or a fluoride-containing organic material having a liquid-repellent property.

The second base 50 is formed in a rectangular plate shape with a thickness of, for example, 100 μm to 775 μm. The second base 50 includes a base material layer 51 formed from, for example, a silicon wafer and a deformation restriction film 52 stacked on a surface of the base material layer 51 opposite to the surface thereof facing the nozzle plate 41. The second base 50 has a plurality of through-holes 50a each configuring a pressure chamber C1 of, for example, a columnar shape. The diameter of the pressure chamber C1 is, for example, 190 μm. The plurality of pressure chambers C1 is formed at respective positions communicating with the respective associated nozzles 41a of the nozzle plate 41, which is located facing the lower surface of the second base 50.

Here, as illustrated in FIG. 4, the hole shape of the pressure chamber C1 has a depth L1 that is greater than a diameter D1, that is, depth L1>diameter D1. Thus, the pressure applied to ink in the pressure chamber C1 can be hindered from escaping to the common chamber C2.

The deformation restriction film 52 reduces a warpage of the second base 50 which may occur when the nozzle plate 41 is integrated with the second base 50. For example, if the deformation restriction film 52 is made of the same material and with the same film thickness as those of the nozzle plate 41, the film stress of the nozzle plate 41 and the film stress of the deformation restriction film 52 at both surfaces of the base material layer 51 are the same, and thus warpage in the second base 50 can be effectively reduced. Therefore, the deformation restriction film 52 can be made of a silicon dioxide (SiO₂) film with a thickness of 4 μm formed by processing the silicon wafer of the base material layer 51 by chemical vapor deposition (CVD) or by heat treatment in the presence of oxygen.

The third base 60 is, for example, stainless steel or ceramic or another material such as a resin, in a rectangular shape. The ceramic is, for example, nitride, carbide, or oxide, such as alumina ceramic, zirconia, silicon carbide, or silicon nitride. The resin is, for example, a plastic material, such as acrylonitrile butadiene styrene (ABS), polyacetal, polyamide, polycarbonate, or polyether sulfone. The material of the third base 60 is selected in consideration of a difference in expansion coefficient from the nozzle plate 41 so as not to have an influence on the generation of pressure for ejecting ink.

The lower surface of the third base 60, facing the second base 50, has a flow path portion 63 formed therein which configures a common chamber C2 communicating with the pressure chambers C1. The flow path portion 63 is a recessed portion with a predetermined depth formed, for example, in a rectangular shape in planar view. The flow path portion 63 includes a region facing the plurality of pressure chambers C1 and configures one common chamber C2 communicating with the plurality of pressure chambers C1.

A supply port 64 and a discharge port 65, each communicating with the ink tank 32, are respectively formed at both end portions of the bottom surface 63a of the flow path portion 63. Each of the supply port 64 and the discharge port 65 is a circular through-hole with an axis thereof extending along the direction Z, through which the common chamber C2 communicates with the connection flow path 33 connected to the ink tank 32. The supply port 64 and the discharge port 65 are respectively located at positions outside the nozzles 41a at both ends in the direction X in which the nozzles 41a are arranged side by side.

An uneven portion 67 configured to hold air bubbles is formed on the inner wall of the flow path portion 63. The uneven portion 67 includes a plurality of grooves 67a arranged side by side in the direction X, each of which extends in the direction Y and has a V-shaped cross section (thus forming V-shaped grooves). The width dimension w1 of each groove 67a is configured, for example, such that w1<D1 holds, and width dimension w1 is set to, for example, 50 μm in the first embodiment. The depth dl of each groove 67a is set to, for example, 50 μm in the first embodiment.

At least one groove 67a is provided at a position opposite to an area between a pair of adjacent pressure chambers C1. In the first embodiment, on the wall surface facing the upper surface of the second base 50, about 4 to 6 grooves 67a are arranged at regular intervals in the direction X between a pair of adjacent pressure chambers C1. Furthermore, the number of grooves 67a to be arranged therebetween is not limited to 4 to 6.

The plurality of grooves 67a continuously extends along the direction Y, and is arranged side by side in the flow direction of a circulating flow F1 in the common chamber C2. Air bubbles flowing to the downstream side together with the circulating flow F1 are trapped by walls forming the grooves 67a.

The following elucidates an operation of the configured inkjet recording apparatus 1 as described above. The CPU 16a detects a printing instruction issued, for example, by a user input in an interface. Then, upon detecting the printing instruction, the CPU 16a drives the conveyance device 15 to convey a sheet P and outputs a printing signal to the head units 30 at predetermined timing to drive the inkjet heads 31. The inkjet heads 31 perform an ejection operation to eject ink from the nozzles 41a by selectively driving the drive elements 48 according to an image signal corresponding to the image data, thus forming an image on the sheet P held on the conveyance belt 18.

In a liquid ejection operation, the CPU 16a operates the drive circuit to apply drive voltages to the drive elements 48 via the wiring layers 43 and 44. Then, the drive element 48 deforms due to the deformation of the piezoelectric element 42. For example, the drive element 48 is deformed in a direction to increase the capacity of the pressure chamber C1 to be driven, thus making the inside of the pressure chamber C1 at negative pressure, so that ink is introduced into the pressure chamber C1. When the drive element 48 is deformed in a direction to decrease the capacity of the pressure chamber C1, the pressure of the inside of the pressure chamber C1 increases, and thus ink droplets are ejected from the nozzle 41a.

The CPU 16a drives the circulation pump 34 to circulate liquid via a circulation flow path which passes through the ink tank 32 and the inkjet head 31. In a circulation operation, ink in the ink tank 32 flows into the common chamber C2 through the supply port 64 following the flow path portion 63, before being supplied to the plurality of pressure chambers C1. Thus, a circulation flow F1 of ink indicated by the arrow in FIG. 4 occurs.

The configured inkjet head 31 as described above has the uneven portion 67 for trapping air bubbles on the wall surface of the common chamber C2. Accordingly, in a liquid ejection operation during which air bubbles intrude from the nozzle 41a at the upstream side into the pressure chamber C1, the air bubbles would be trapped by the uneven portion 67 in the process of flowing to the downstream side even though they flow into the common chamber C2 along the circulation flow F1 of ink. The air bubbles that are trapped by the uneven portion 67 and remain in the common chamber C2 would then be dissolved in the ink and thus naturally disappear.

In summary, according to the inkjet head 31, since air bubbles are drawn to remain at positions away from the nozzles 41a and are thus prevented from flowing to the nozzles 41a at the downstream side, ejection failure due to air bubbles can be prevented or reduced.

Furthermore, in the inkjet head 31, since the uneven portion 67 is configured to have the grooves 67a extending in a direction approximately perpendicular to the longitudinal direction of the common chamber C2, in other words, in a direction perpendicular to the flow direction of the circulation flow F1 of ink, air bubbles moving toward the pressure chambers C1 at the downstream side can be easily trapped and many air bubbles can be drawn to join up the trapped air bubbles. Accordingly, air bubbles can be reliably trapped, and thus a high ejection performance can be attained.

Furthermore, the present disclosure is not limited to the specific example embodiments described herein, and various modification of constituent elements within the range not departing from the gist of the present disclosure may be made.

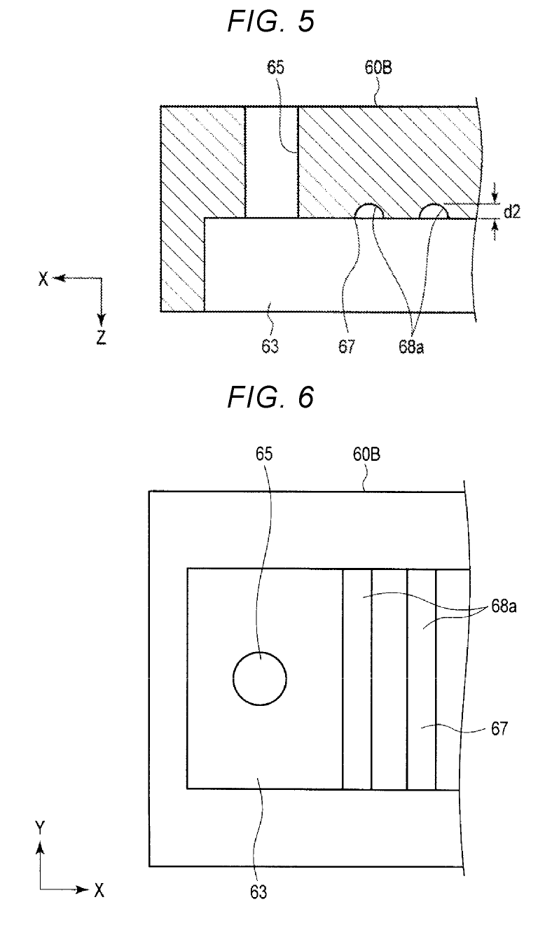

While in the above-described first example embodiment, the uneven portion 67 has the grooves 67a formed therein with a V-shaped cross section with a width reducing toward the bottom side, the present disclosure is not limited to this example. For example, according to a second embodiment, as in a third base 60B illustrated in FIG. 5 and FIG. 6, the uneven portion 67 can have a plurality of grooves 68a having a semicircular cross section.

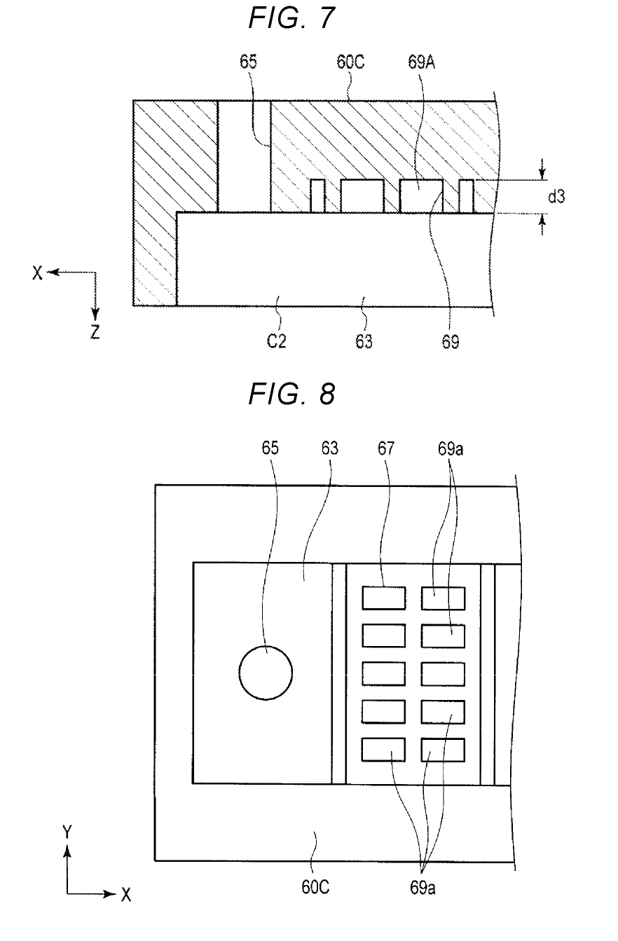

Moreover, while the uneven portion 67 in the above-described first example embodiment has the grooves 67a formed therein, each of which continuously extends in the direction Y and has a V-shaped cross section, the present disclosure is not limited to this example. For example, according to a third embodiment, as in a third base 60C illustrated in FIG. 7 and FIG. 8, a plurality of grooves 69a, each of which is open toward the pressure chamber and has a predefined width in a rectangular parallelepiped shape, can be intermittently arranged side by side in the direction Y spaced at an interval along with those continuously extending grooves. The third bases 60B and 60C in the second and the third embodiments also have an advantageous effect similar to that in the first embodiment.

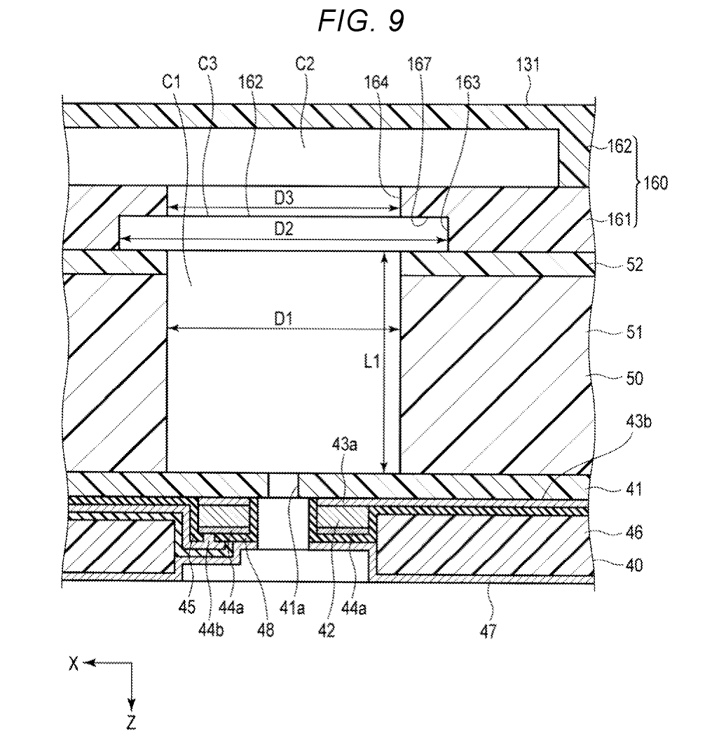

FIG. 9 is a cross-sectional view of an inkjet head 131 according to a fourth embodiment. The inkjet head 131, according to the fourth embodiment, has a circumferential groove 167 having a step difference formed on an inner circumferential wall communicating with the pressure chamber C1 as an uneven portion 67 instead of the grooves 67a.

A third base 160 of the inkjet head 131 includes a first plate 161 and a second plate 162 which are stacked in layers.

The first plate 161 is for example, stainless steel or ceramic or another material such as a resin, in a rectangular shape. The first plate 161 has a connection path C3 formed therein which communicates with the pressure chamber C1. The connection path C3 is a through-hole having a step difference, and has a large-diameter hole 163 and a small-diameter hole 164 in succession. Thus, in the fourth embodiment, the common chamber C2 has the connection path C3, which communicates with the pressure chamber C1 and the flow path diameter of which expands and reduces.

The diameter D2 of the large-diameter hole 163 of the connection path C3 is set larger than the diameter D1 of the pressure chamber C1, and the diameter D3 of the small-diameter hole 164 is set equivalent to the diameter D1 of the pressure chamber C1. For example, the diameters D1, D2, and D3 are set to 190 μm, 210 μm, and 190 μm, respectively.

Furthermore, since the first plate 161 of the third base 160 acts as a separate plate which confines pressure generated in the pressure chamber C1 and prevents pressure from escaping to the common chamber C2 when a pressure change occurs in ink inside each ink pressure chamber C1 to eject ink from each nozzle 41a, the diameter D3 can be set equal to or less than ¼ of the diameter of the pressure chamber C1.

The second plate 162 is made of, for example, stainless steel or ceramic or another material such as a resin, in a rectangular shape. The lower surface of the second plate 162 facing the first plate 161 and the pressure chamber C1 has a flow path portion 63 formed therein, serving as the common chamber C2 communicating with the pressure chamber C1. The flow path portion 63 is a recessed portion with a predetermined depth formed, for example, in a rectangular shape in planar view. The flow path portion 63 includes a region facing the plurality of pressure chambers C1 and configures one common chamber C2 communicating with the plurality of pressure chambers C1 via a plurality of connection paths C3.

A supply port 64 and a discharge port 65 each communicate with the ink tank 32 and each respectively formed at both end portions of the bottom surface 63a of the flow path portion 63.

The inkjet head 131 according to the fourth embodiment also has an advantageous effect similar to that of the inkjet head 31 according to the above-described first embodiment. More specifically, in the inkjet head 131, air bubbles can be trapped by the circumferential groove 167 formed on the inner circumferential wall of the connection path C3, which is an inner wall of a part of the common chamber C2, as an uneven portion. Accordingly, air bubbles can be prevented from moving to the nozzles at the downstream side, so that ejection failure can be avoided.

Furthermore, in the inkjet head 131, when a pressure change occurs in ink inside each ink pressure chamber C1 to eject ink from each nozzle 41a, the first plate 161 of the third base 160 is also able to act as a separate plate which confines pressure generated in the pressure chamber C1 and prevents pressure from escaping to the common chamber C2.

While the inkjet head 31 or 131 in the above-described embodiments include three distinct bases (40, 50, and 60 or 160), the present disclosure is not limited to this example, and the inkjet head 31 or 131 may include one integrated base or only two distinct bases. Likewise, the inkjet heads 31 or 131 may include four or more bases in combination.

Moreover, the materials used for various portions are not limited to those specifically described or listed in the above-described embodiments, and can be changed as appropriate. For example, the nozzle plate 41 can be formed by depositing a silicon dioxide (SiO₂) film on a silicon wafer surface by chemical vapor deposition (CVD). Furthermore, the nozzle plate 41 can be formed from a stacked film having a plurality of layers. Additionally, instead of SiO₂ as the material for the nozzle plate 41, a semiconductor material, such as silicon nitride (SiN), or aluminum oxide (Al₂O₃) can also be used.

The base material layer of the second base can be, for example, a semiconductor, such as silicon carbide (SiC) or germanium substrate. Furthermore, the base materials are limited not only to a semiconductor material, but can also be another material, such as ceramic, glass, quartz, resin, or metal. The ceramic can be, for example, a nitride, a carbide, or an oxide, such as alumina ceramic, zirconia, silicon carbide, silicon nitride, or barium titanate. The resin can be, for example, a plastic material, such as acrylonitrile butadiene styrene (ABS), polyacetal, polyamide, polycarbonate, or polyether sulfone. Metals can be, for example, aluminum or titanium.

Furthermore, the material used to form the piezoelectric element 42 is limited not only to the above-mentioned materials, but can also be, for example, various piezoelectric materials, such as lead titanate (PTO (PbTiO₃)), lead magnesium niobate titanate (PMNT (Pb(Mg_{1/3}Nb_{2/3})O₃—PbTiO₃)), lead zinc niobate titanate (PZNT (Pb(Zn_{1/3}Nb_{2/3})O₃—PbTiO₃)), zinc oxide (Zn0), and aluminum nitride (AlN).

The material used to form the wiring layers 43 and 44 is limited not only to the above-mentioned materials, but can also be, for example, other conductive materials, such as nickel (Ni), copper (Cu), aluminum (Al), silver (Ag), titanium (Ti), tungsten (W), molybdenum (Mo), and gold (Au).

The material of the protective layer 46 is also not limited to the above-mentioned materials. For example, another type of a plastic material, such as acrylonitrile butadiene styrene (ABS), polyacetal, polyamide, polycarbonate, or polyether sulfone, can also be used to form the protective layer 46.

The material to be ejected is limited not only to ink for printing, but can also be other liquids such as a high-viscosity liquid containing conducting particles. For example, the present embodiments can also be applied to a wiring pattern drawing apparatus which ejects a metal wiring material onto a packaging substrate.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid ejection head, comprising:
a first base having a plurality of nozzles from which liquid can be ejected;
a second base on the first base and having a plurality of pressure chambers in fluid communication with the plurality of nozzles; and
a third base located on the second base, with the second base being interposed between the first and third bases, the third base having a common chamber in fluid communication with the plurality of pressure chambers, an inner wall of the common chamber has an uneven surface portion shaped so as to trap air bubbles entrained in the liquid to be ejected from the plurality of nozzles.

2. The liquid ejection head according to claim 1, wherein the uneven surface portion includes at least a recessed portion at a position opposite to an area between a pair of adjacent pressure chambers.

3. The liquid ejection head according to claim 2, wherein the uneven surface portion comprises a plurality of grooves extending in a first direction along the inner wall.

4. The liquid ejection head according to claim 2, wherein the uneven surface portion comprises a plurality of grooves intermittently spaced at an interval in a first direction along the inner wall.

5. The liquid ejection head according to claim 1, wherein the uneven surface portion includes a circumferential groove forming a step difference on an inner circumferential wall of a through-hole of the third base, each through-hole corresponding to a pressure chamber in the second base.

6. A liquid ejection apparatus, comprising:
a first base having a plurality of nozzles from which liquid can be ejected;
a second base on the first base and having a plurality of pressure chambers in fluid communication with the plurality of nozzles;
a third base located on the second base, with the second base being interposed between the first and third bases, the third base having a common chamber in fluid communication with the plurality of pressure chambers, an inner wall of the common chamber has an uneven surface portion shaped so as to trap air bubbles entrained in the liquid to be ejected from the plurality of nozzles; and
a conveyance device configured to convey a medium along a predetermined conveyance path.

7. The liquid ejection apparatus according to claim 6, wherein the uneven surface portion includes at least a recessed portion at a position opposite to an area between a pair of adjacent pressure chambers.

8. The liquid ejection apparatus according to claim 7, wherein the uneven surface portion comprises a plurality of grooves extending in a first direction along the inner wall.

9. The liquid ejection apparatus according to claim 7, wherein the uneven surface portion comprises a plurality of grooves intermittently spaced at an interval in a first direction along the inner wall.

10. The liquid ejection apparatus according to claim 6, wherein the uneven surface portion includes a circumferential groove forming a step difference on an inner circumferential wall of a through-hole of the third base, each through-hole corresponding to a pressure chamber in the second base.

11. A liquid ejection head, comprising:
a plurality of nozzles in a base;
a plurality of pressure chambers fluidly connected to the plurality of nozzles; and
a common chamber fluidly connected to the plurality of pressure chambers; and
an uneven surface portion on an inner wall of the common chamber, the uneven surface portion being shaped so as to trap air bubbles entrained in a liquid to be ejected from the plurality of nozzles.

12. The liquid ejection head according to claim 11, wherein the uneven surface portion includes at least a recessed portion at a position opposite to an area between a pair of adjacent pressure chambers.

13. The liquid ejection head according to claim 12, wherein the uneven surface portion comprises a plurality of grooves extending in a first direction along the inner wall.

14. The liquid ejection head according to claim 12, wherein the uneven surface portion comprises a plurality of grooves intermittently spaced at an interval in a first direction along the inner wall.

15. The liquid ejection head according to claim 11, wherein the uneven surface portion includes a circumferential groove forming a step difference on an inner circumferential wall of a through-hole corresponding to a pressure chamber.
